(19) United States
(12) Patent Application Publication
(10) Pub. No.: US 2014/0136309 A1
(43) Pub. Date: May 15, 2014

(54) SYSTEM AND METHOD FOR OPTIMIZING CARD USAGE IN A PAYMENT TRANSACTION

(71) Applicant: WALLABY FINANCIAL INC., Pasadena, CA (US)

(72) Inventors: Matthew Alexander GOLDMAN, Pasadena, CA (US); Todd ZINO, Los Angeles, CA (US)

(73) Assignee: WALLABY FINANCIAL INC., Pasadena, CA (US)

(21) Appl. No.: 13/678,479

(22) Filed: Nov. 15, 2012

(51) Int. Cl. G06Q 30/02

(52) U.S. Cl. CPC G06Q 30/0226
USPC 705/14.27; 705/44; 705/16

(57) ABSTRACT

Systems and methods for enabling a user to use a single financial card in a payment transaction for optimizing card rewards are disclosed. A database having a plurality of payment instruments such as credit cards, debit cards and stored value cards associated to the user's provided single financial card is provided.

### FIELD

The present disclosure relates to systems and methods for optimizing usage of payment instruments in a payment transaction. More in particular, it relates to a system and method for optimizing card usage in a payment transaction.

### BACKGROUND

Increasingly, reward programs have become commonplace in the credit card industry. These loyalty rewards programs offer cash back, rebate, air miles, points, hotel rewards and more. In addition, these rewards have rules that apply to a particular type of transaction, a specific merchant, the amount of purchase and other forms. It can be nearly impossible to keep track of all the reward offers for purchases especially for programs that change and/or rotate on a frequent basis.

Furthermore, card users may opt to carry multiple cards so they can use the one with the best rewards at any particular merchant or type of transaction at the time of purchase. In doing so, keeping track of this complex process becomes a burden to the cardholders.

Card users may also desire to direct spending onto various credit card payment tools based on other factors affecting the cost of using such cards or to affect other financial measures, such as their credit score as reported by one of the consumer credit bureaus.

### SUMMARY

According to a first aspect, computer implemented method of optimizing usage of payment instruments for an individual is described, the method comprising: establishing an intermediary account comprising an optimization engine, the intermediary account being associated with a plurality of payment instruments; receiving, by the optimization engine, a first transaction approval request from a single financial card provided by the individual; processing, by the optimization engine, instructions provided from one or more databases, the one or more databases comprising merchant offer instructions, payment instrument offer instructions, privacy instructions, and preference instructions; selecting, by the optimization engine according to the instructions, one or more payment instruments from the plurality of payment instruments to charge a requested amount; and transmitting a second transaction approval request to the selected one or more payment instruments, the second transaction approval request being a forwarded request of the first transaction approval request, thus sending the first transaction approval request to the selected one or more payment instruments via the optimization engine.

According to a second aspect, computer implemented method of optimizing payment instrument usage for an individual is described, the method comprising: establishing an intermediary account through the computer; associating, through the computer, a plurality of payment instruments with the intermediary account; performing a point-of-sale (POS) transaction on a merchant card processing device, wherein the transaction comprises requesting an approval to execute the POS transaction; routing the request, by the computer, to the intermediary account; determining, by the intermediary account through the computer, one or more payment instruments from the plurality of associated payment instruments, that provides a maximum reward for the individual according to instructions stored in one or more databases associated with the intermediary account; and routing the request, by the computer, to a payment instrument issuer of the determined one or more payment instruments, thus requesting an approval or disapproval from the payment instrument issuer.

According to a third aspect, computer implemented system is described, the system comprising: a server connected with a network, the server comprising an optimization engine configured to optimize usage of payment instruments for an individual according the method of claim 1, and a plurality of databases configured to store a list of attributes and preferences associated with the individual's record; and a merchant payment system connected to the server through the network, the merchant payment system configured to route a point-of-service (POS) transaction from a merchant to the server, and from the server to a selected one or more payment instrument.

### BRIEF DESCRIPTION OF THE DRAWINGS

The systems and methods of the present disclosure will be described with reference to several figures, which are provided herewith as non-limiting examples. In particular:

FIG. 1 shows an overview of a system in accordance with various embodiments of the present disclosure.

FIG. 2 shows an example screen display used in adding a payment instrument to the account.

FIG. 3 shows a flow chart that shows how transaction data is used in the system to determine the optimized rewards for the transaction and how the transaction is then routed to the correct payment instrument.

FIG. 4 shows an example screen display used in creating rules to optimize rewards calculation.

FIG. 5 shows an example screen display of a companion mobile app depicting rewards/savings notification.

FIG. 6 is a flow chart showing how to associate multiple payment instruments with a financial card, configure rewards rule and rewards valuation, configure alert notifications and linking of external services.

FIGS. 7A-7B show detailed flow diagrams of an exemplary consumer transaction and an intermediary transaction according to embodiments of the present disclosure.

FIG. 8 shows a flow diagram of an exemplary decision making process of an optimization engine according to a set of rules.

FIG. 9 shows a computer system that can be used to implement the system for optimizing card usage in a payment transaction.

### DETAILED DESCRIPTION

Embodiments of the present disclosure seek to address the aforementioned problems by providing a system and method for enabling a user to use a single financial card in a payment transaction for optimizing card rewards. The provided single financial card can be associated to different types of payment instruments such as credit cards, debit cards, ATM cards and stored value cards (e.g., gift cards). Such payment instruments can be stored in a database in an intermediary account that is accessible by the financial card upon receipt of payment transaction request from a merchant's processor. The card enables the user to use one single card to mediate and route the transactions to the plurality of payment instruments that provide the best reward value for that transaction. This can be achieved by calculating the rewards valuation for each payment instrument to determine the best rewards based on rules configured by the user. The chosen payment instrument is then selected to route the transaction.

A payment device is a tool known to the local payments system that allows for merchants and banks to communicate monetary value with each other and debit or credit an amount from such device to enable a consumer to make a payment or receive a credit from a merchant. Payment devices can include cash, checks, credit cards, debit cards, ATM cards, and stored value cards (e.g., gift cards).

A credit card is a payment device that is associated with a line of credit provided by a bank. Credit cards may be processed directly between an individual merchant and a banking institution (e.g., a “store credit card” or a “closed loop credit card”). Credit cards may also be processed through a payment network or association (e.g., MASTERCARD® or VISA®) such as to allow a merchant to accept a card from a variety of banking institutions providing the line of credit to the consumer. A debit card is a payment device that is connected to a stored value account related to a checking or demand deposit account and may be used for cash withdrawals or purchases. A stored value card is a sub-form of a debit card connected to a stored value account excluding a checking account. An ATM card is a card connected to a checking account that may be used for cash withdrawals at an automated teller machine or bank teller. The network acts as an interchange to allow for an open loop network between any bank, any consumer and any merchant participating in the particular network. Each participant may participate in one or more networks.

In the art of payment systems, a payment instrument is provided to a merchant at a point of sale in which the information on the card is read along with the transaction data to the merchant's card processing device for approval from the card issuer that maintains the cardholder's account. Upon approval or disapproval from the card issuer, the merchant processes the sales if approved, or cancels the sales if disapproved. The terms “cardholder”, “account holder”, and “user” can be used interchangeably in the present disclosure and are intended to refer to a person or an entity to whom the card (e.g., financial card, credit card, debit card) is issued, from the card issuing institution (e.g., bank).

This approval request passes through a series of processors. Each processing entity acts to receive and forward individual requests across its constituents. A merchant processor (also interchangeable with the terms “merchant gateway” or “merchant acquirer”) directly connects to a merchant's point of sale system and directs the request to the correct payment interchange network. The payment interchange network has a processing platform which determines which card processor and payment instrument issuing banking institution is to receive the request in the chain for approval. The card processor, as described above, is directly connected with the banking institution to perform decision making on the transaction. The merchant's card processing device typically interacts with an acquiring system which sends the request to a card network such as, for example, AMERICAN EXPRESS®, DISCOVER®, MASTERCARD®, VISA® and others. The card network then obtains approval from the processing or issuing bank of the payment instrument. The approval or disapproval of the transaction is transmitted back to through the same chain of processors.

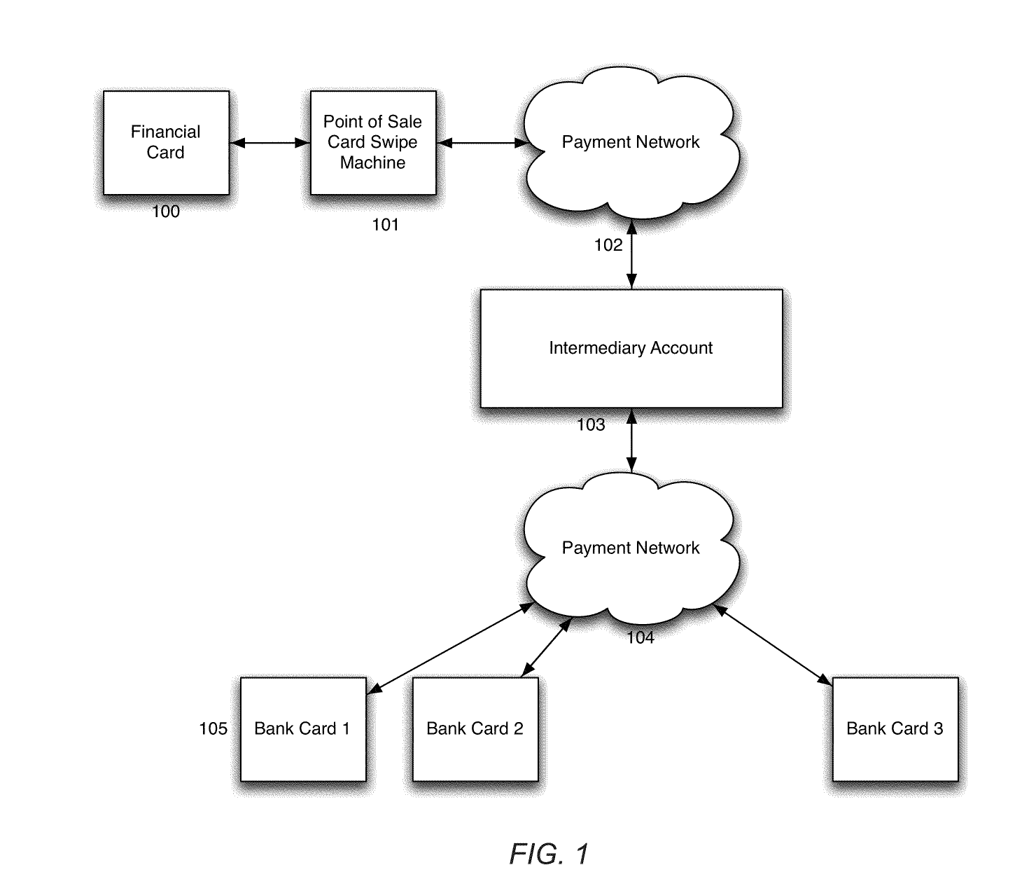

Differently from the payment systems known in the art, FIG. 1 shows an exemplary payment system according to various embodiments of the present disclosure, having an intermediary account (103) such that when the cardholder presents a financial card (100) to a merchant at the point of sale, and the information on the card is read along with the transaction data to the merchant's card processing device (101), the approval process undergoes a two-step process. In other words, when the payment approval request is initially sent from the merchant's card processing device (101), the request is initially sent to the intermediary account (103) through a first payment network (102) for processing.

As mentioned previously, the intermediary account (103) can be configured such that the financial card is associated with a plurality of payment instruments so that the plurality of payment instruments can be accessible by using the single financial card (100). Therefore, once the approval request is received by the intermediary account (103), the intermediary account processes the request and determines which of the one or more payment instruments the request should be further forwarded to. Once this decision is made, the intermediary account (103) sends the approval request through a second payment network (104) to the card issuer (105) (e.g., banking institution) of the payment instrument that was selected by the intermediary account (103). The specific steps of the approval process and processing by the intermediary account (103) will be described in further detail later.

A card processor is a technology platform that is directly connected to one or more payment networks and acts as conduit for receiving transactions from the payment network, and storing the transactional history and account of record balance for the banking institution issuing the payment instruments.

In accordance with several embodiments of the present disclosure, a financial card is provided, which can act as a conventional credit card or debit card. For instance, the card may have the form, fit and function of a conventional credit, bank or stored value card. In some embodiments, the financial card can be an embossed plastic card including machine readable data accessible via a magnetic strip, chip, RFID or other forms. The card can have distinguished identification of the bank or financial institution that issued the card. The card can be embossed with identification information that renders the card unique to the cardholder. The identification information can include the name and an account number of the cardholder. In other embodiments, the financial card may not necessarily be in the form of an actual card. Instead, the financial card can be, by way of example and not of limitation, a portable electronic device with a computer readable medium comprising information that is contained in a credit card or a debit card (e.g., name and account number). Such information can be provided to the merchant's card processing device via wireless protocol such as near field communication (NFC), Bluetooth®, WIFI®, or a barcode embedded in or on the card.

Although the terms “payment instrument” and “financial card” can be used to refer to credit cards, debit cards, and/or stored value cards in the present disclosure, the term “financial card” is intended to refer to the card that is provided by the user to the merchant during a purchase transaction at the point of sale. The term “payment instrument” is intended to refer to the card that is associated (e.g., linked) with the financial card through the intermediary account.

The payment instruments that can be associated with the financial card of the present disclosure can include credit card accounts, bank accounts, debit accounts and stored value card accounts. The financial institution issuing the payment instrument maintains accounts for the cardholder that are each accessed by the financial card so that the card can have all the functions of a credit card, all the functions of a bank, debit and all the functions of a stored value card.

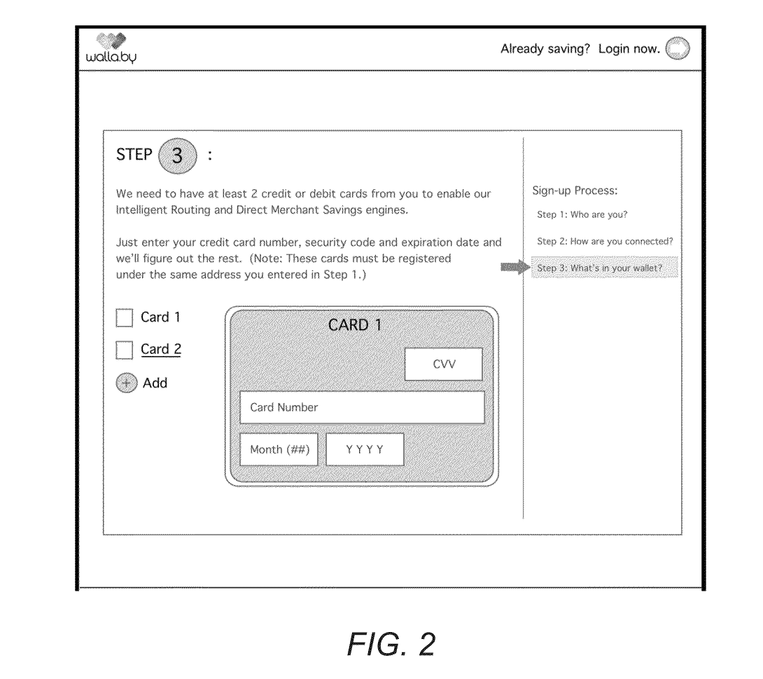

The intermediary account can be accessible by the account holder via, for example an Internet browser or an application running on a phone, smartphone, tablet, handheld device or computing devices connected to a secure system via the Internet. FIG. 2 shows an exemplary screenshot of a webpage that can be accessible by the account holder. By accessing this webpage, the account holder can associate one or more payment instruments to his or her intermediary account by entering, for example, the card number, expiration date, and secure card code (e.g., CVV).

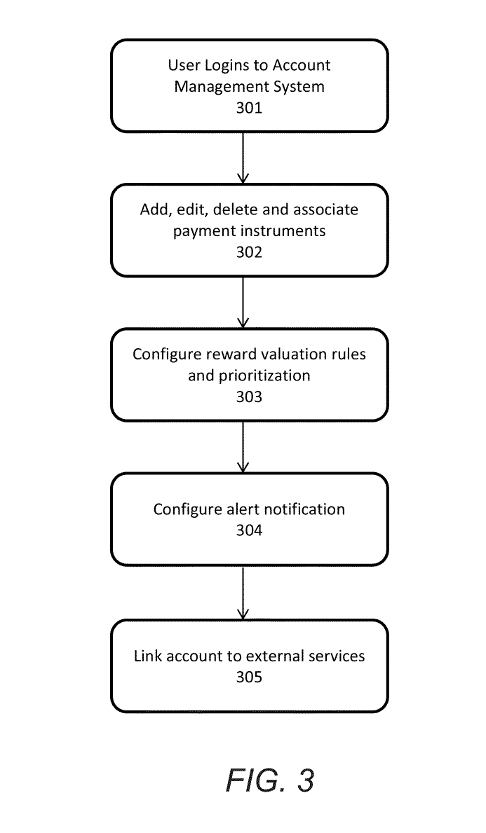

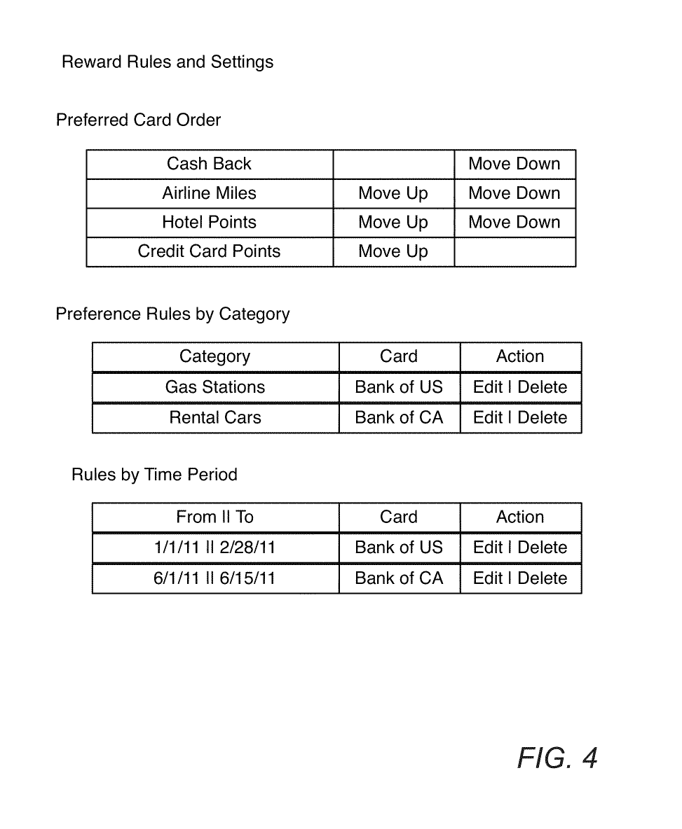

FIG. 3 is a flow chart describing the steps involved in setting up the intermediary account. By way of example and not of limitation, the account holder first logs in to his or her account (301). Once the account holder logs in, the account holder can add, edit, or delete one or more payment instruments from the account (302), thus associating such payment instrument to the intermediary account, as also described in the previous paragraph and shown in FIG. 2. By adding one or more payment instruments to the intermediary account, the payment instrument information is stored in a database, which can be located within a server. Once the payment instruments are entered in the intermediary account, the account holder can store reward valuation and prioritization information for each payment instrument (303). The information gathered by the system in this step allows optimization, by way of a decision logic, of the rewards awarded to the account holder once a payment transaction is received from the merchant card processor, which will be described in further detail later. An exemplary screenshot of a webpage where the account holder can enter or edit reward valuation and prioritization information is shown in FIG. 4.

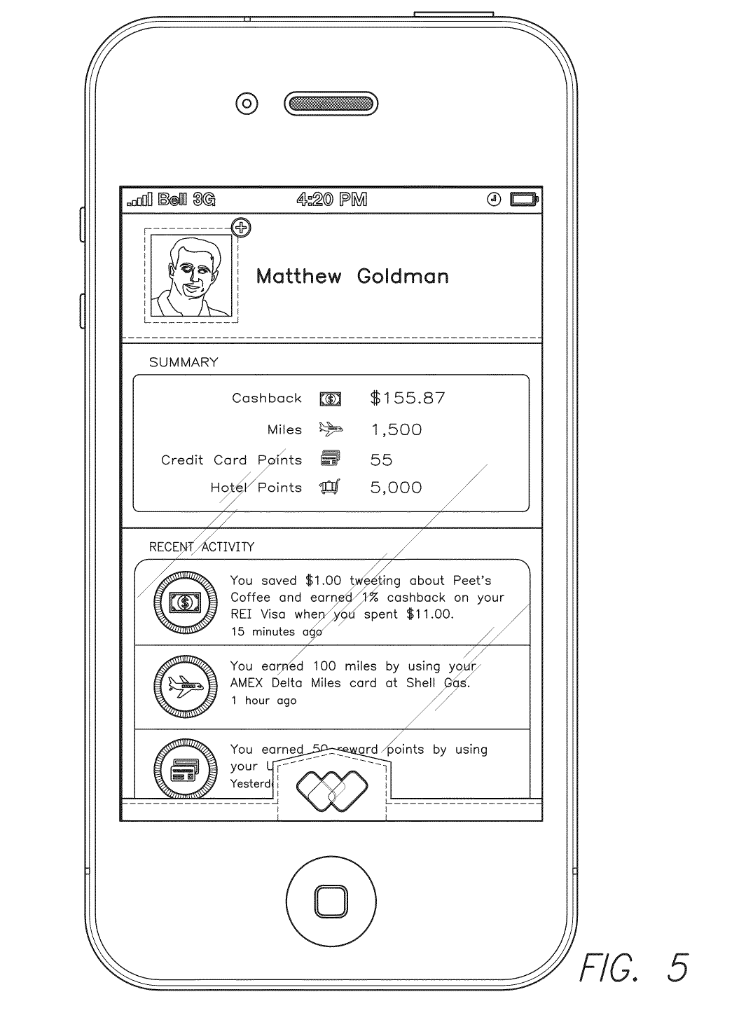

Turning back to FIG. 3, once the reward valuation and prioritization information is configured, the account holder can configure alert notification preferences (304). The alert notification can be provided via an app, an email, an SMS text, or social media feeds, for example, every time an approval request is sent to one of the associated payment instrument. In some embodiments, the account holder can configure the intermediary account to send such alert notification every time the approval request is approved or disapproved by the payment instrument issuing bank, or the amount of earnings or savings of their rewards incentives, as shown with an example screenshot in FIG. 5. Finally, the intermediary account can be linked to external services (305) if given explicit permission by the users. By way of example and not of limitation, the external services can include social media services (e.g., FACEBOOK®, TWITTER®, FOURSQUARE®) or other financial services where the users can choose to enable real-time notifications to be generated and submitted. By enabling such real-time notification, the users can share, track and maintain purchase and shopping history.

With continued reference to FIG. 4, different forms of reward valuation and prioritization can be stored as metadata and used for the decision logic in determining which payment instrument to be utilized. This information can be used as rules to make decisions for each payment transaction. By way of example and not of limitation, such metadata information can include, reward types (e.g., air mileage, points, cash back rebates), transaction category (e.g., travel, gas, food), and time based information (e.g., July, December, promotional period). These rules can also be combined with stored account holder's privacy preferences and considered when processing and deciding which payment instrument to send the approval request.

In some embodiments, the user can configure the optimization engine to prioritize according to one or more combination of balance management, interest charges, fees, and statement closing dates. According to a first embodiment where the user chooses balance management, the user can configure the optimization engine to manage their spending in two sub-forms: a) by percentage of credit utilized, and b) by balance relative to other cards.

In sub-form (a), the optimization engine queries the current balance of the card and the current credit limit of the card via a connection to the user's bank (e.g., online access authorized by the user's credentials, other methods specified by the bank, involving a third party aggregation service). According to incoming transactions, past history and pacing in the course of the month transactions, new charges are routed to individual cards in such a way to ensure total charges on the financial instruments do not exceed a limit specified by the user.

In sub-form (b), the optimization engine queries the balance as mentioned above in sub-form (a), but based on past history and the current day of the month paces out balances among the cards to achieve the most even balance or any ratio selected by the user.

According to another embodiment of the present disclosure, the users can configure the optimization engine to minimize interest charges due to the bank by the user, for users that carry a balance. The same account management method as described above can be employed to query the current interest rate and balance. As rates change and a user's spending and payment history is established, further spending is distributed in such a way as to minimize the fees. For example, if user has two cards, one with a 10% rate and one with a 20% rate, and the user will charge $1000 this month and pay off $500. $450 is distributed to the 20% rate card for immediate pay down, and the remaining $550 is distributed to the card with the 10% rate. $500 is carried at 10% and the remainder is paid as a minimum.

According to another embodiment of the present disclosure, spendings can be distributed across financial cards so as to reduce fee charged by the banks for various activities. For example, some banks may charge transaction fees for certain transactions on certain cards but not on others.

According to another embodiment of the present disclosure, spendings can be distributed based on closing dates of bank statements. In a first method, a user can request that no charges greater than a set amount be charged immediately prior to the closing date, therefore gaining additional grace period days to pay the charges. For example, a user can provide the closing date of their statements and charges are not posted to cards within 3 days of closing. In another method, the user may request that grace periods be maximized for all purchases. In such case, new charges are distributed to the financial card having the furthest closing date.

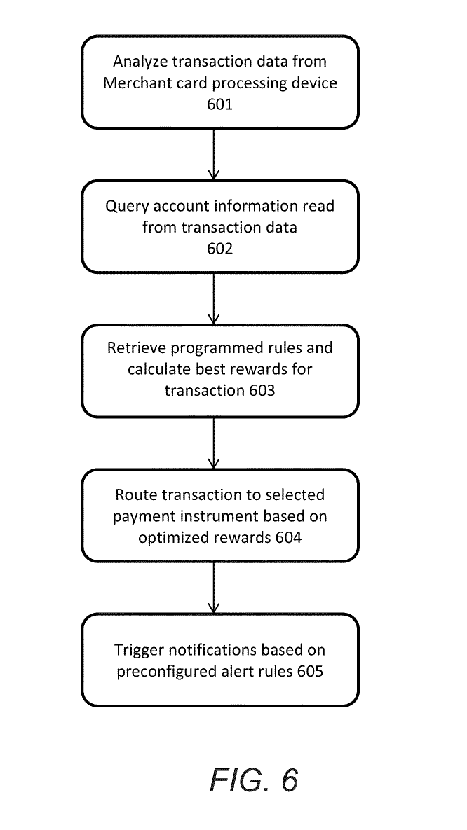

In some embodiments, the intermediary account comprises an optimization engine comprising a decision logic configured to automatically select one or more payment instruments when an approval request is received by the intermediary account. The “optimization engine” can be defined as a process that takes place in the computer of the intermediary account, that determines which payment instrument (out of the list of payment instruments associated with the intermediary account) to forward the approval request from the merchant, by processing the approval request according to the various rules and preferences set by the user and/or provided by the payment instrument issuer. Inputs to the optimization engine can include, but are not limited to user inputs, availability of cards, merchant of transaction, amount of transaction, date of transaction, user spending history and forecast and rewards program rules, all of which will be described in more details later. FIG. 6 shows a flow of information of how an approval request of a payment transaction is routed in determining the payment instrument to route the approval request based on a predefined and/or stored set of rules. Initially, the decision logic analyzes the transaction data from the merchant's processing device (601). Such transaction data can include status of the account at the time of the transaction, type of merchant, or type of goods and/or service involved in the transaction, the identity of the merchant, the location of the transaction and the amount of the transaction. The decision logic then queries account information obtained from the transaction data (602). By way of example and not of limitation, the transaction data can include merchant name, merchant type, transaction amount and a time stamp. The optimization engine can then read this information from the transaction data as an input to its decision making routine. The programmed rules may cause the transaction to be routed based on any of the data, or combination of the data, received regarding the transaction. The conditions for each potential routing scenario can be programmed in the form of routing rules (603).

Based on the best reward calculated and processed in step (603), the decision logic can then route the approval request associated to the selected payment instrument (604). Once the approval request is routed to the selected payment instrument, the user is notified with information pertaining to the transaction (e.g., selected payment instrument, amount, point earned, etc.) according to notification preferences set by the user and/or preconfigured alert rules (605). By way of example and not of limitation, an algorithm can consider the contents of the payment instrument associated with the user's account (e.g., the payment instruments available), the user's preference for earnings or other optimization routine, specific information pertaining to the transaction of the request such as, merchant name, merchant category, time of transaction, amount of transaction, available offers or rewards specific to either the payment instrument or the specific merchant of the transaction, or any combination thereof. The algorithm computes the optimized choice to maximize total dollar value awarded (or saved) to the user. The value of the award can be determined by the offers available, value of points earned and modified by nearness of any given point balance in a program to certain milestones. The decision logic discussed above not only performs calculation of the best rewards but also determines the choice of the best payment device. For example, when an account holder uses the associated financial card of the present disclosure in a point of sale, additional data is passed through and used from the transaction.

In some embodiments, the algorithm rules used by the decision logic can be created manually by a user inputting the rules directly into a database of the intermediary account, for example, by way of a web browser having access to the intermediary account. Such rules can include, but not be limited to the user's preferred earning method, specific preferences or payment instruments for merchant categories, time frames and amounts. The user can also create override rules such as preferring certain payment instruments for transactions taking place during a certain time periods, or override rules that prevent payment instruments from being charged if that particular payment instrument's monthly billing cycle will close within two days. Rules can be stored within a database accessible to the decision logic algorithm that is processed by the optimization engine. The database can be programmed by additional support processes for parsing rewards program data from various payment cards.

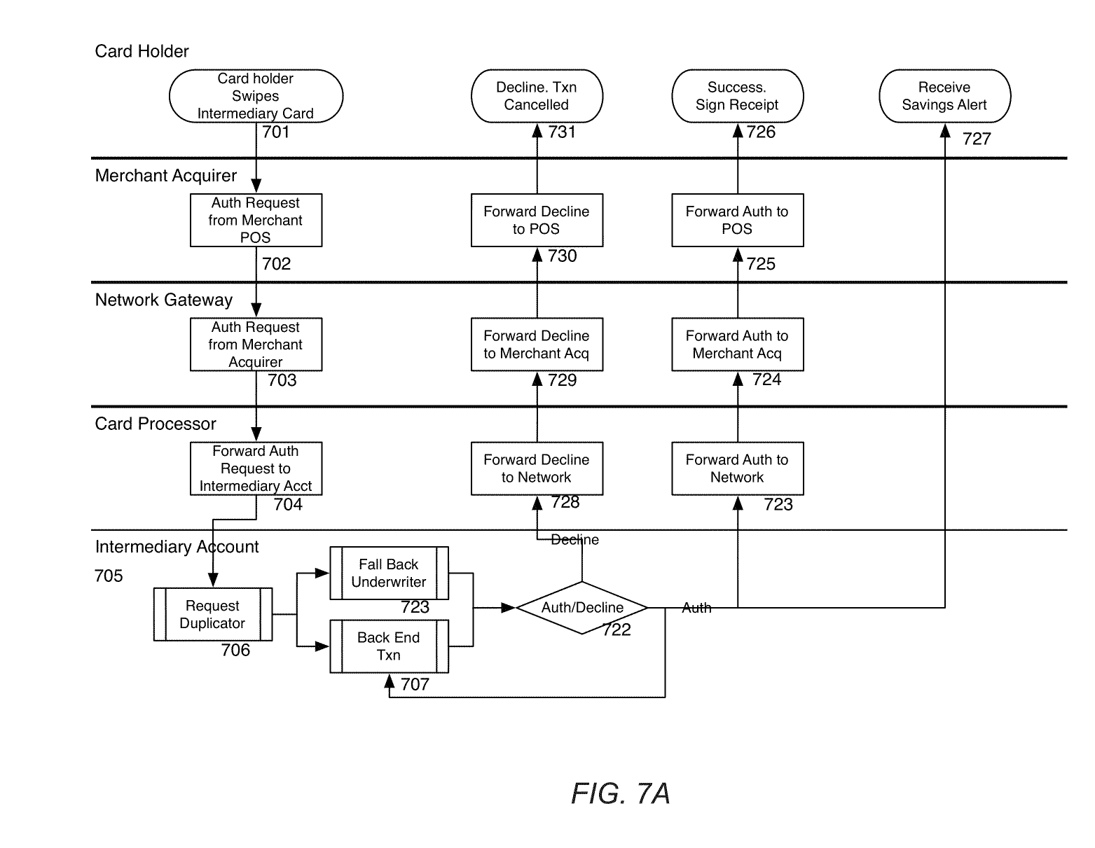

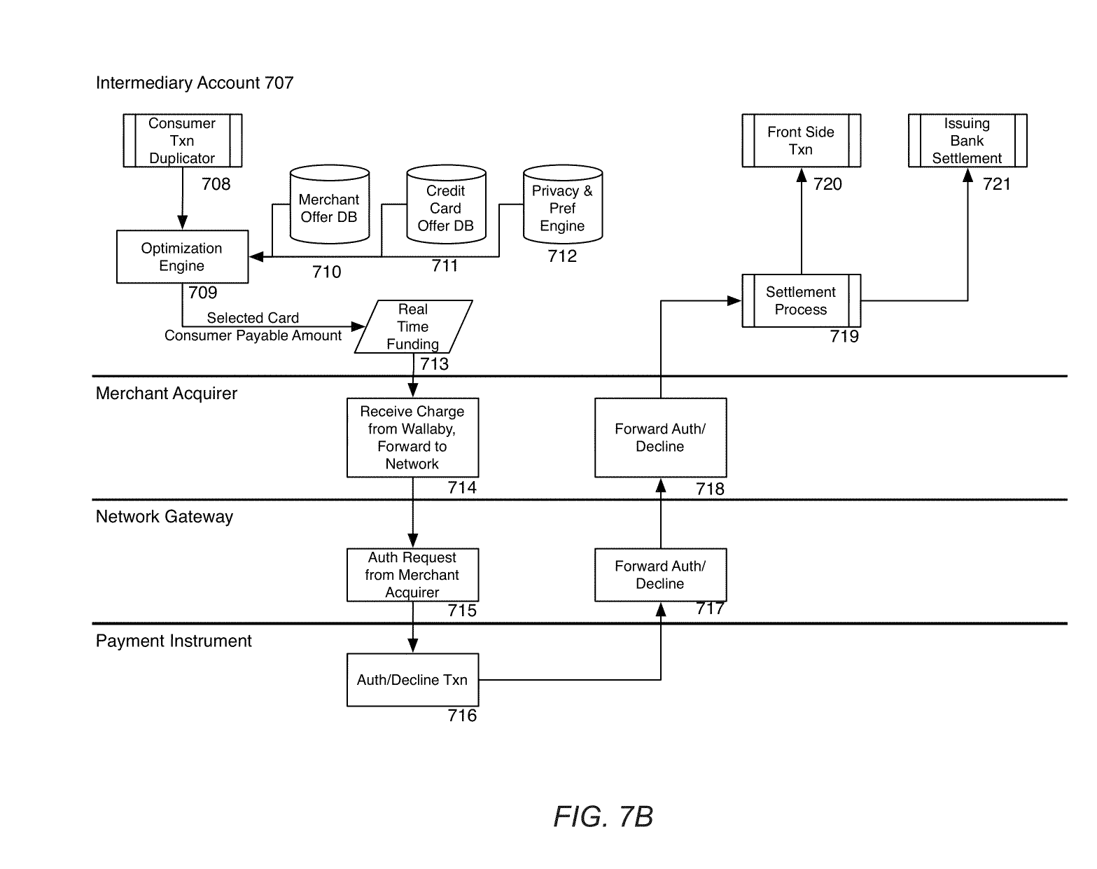

FIGS. 7A and 7B show a further detailed flow diagram of an exemplary transaction according to the embodiments of the present disclosure. As known by those skilled in the art, swim lanes are shown to illustrate the process flow in order to describe which actor is performing the described action. In an initial step performed by the cardholder (or anyone on behalf of the cardholder such as the merchant, cashier, etc.), the card is read (701) using a merchant card processing device (e.g., magnetic card swiper, wireless card reader) connected to a machine such as a computer or a cash register. The machine sends a request for approval to an intermediary account (705) to charge a certain amount of money via a first merchant acquirer (702), a first network gateway (703) (e.g., VISA®, MASTERCARD®) and a card processor (704). The first merchant acquirer (702), a first network gateway (703) (e.g., VISA®, MASTERCARD®) and a card processor (704) are referred to as the first payment network in FIG. 1. Once the request arrives at the intermediary account (705), the request can initially be received by a request duplicator (706) which can route the request to a plurality of places.

According to an embodiment of the present disclosure, the request is forwarded to a back end transaction process (707). The details of such back end transaction is shown in greater detail in FIG. 7B. In the backend transaction process, the request starts at a consumer transaction duplicator (708) where the authorization request is forwarded to an optimization engine (709). The optimization engine (709) takes the request and decides which payment instrument from the plurality of associated payment instruments, to further forward the request to. The decision process can be performed by the optimization engine (709) according to a set of rules (e.g., algorithm) based on further information provided by a plurality of databases connected with the optimization engine (709). Such databases can include, for example, a merchant offer database (710), a payment instrument offer database (711), privacy and preferences database (712), or any other types of databases that can be recognized by those skilled in the art.

In particular, the merchant offer database (710) can comprise information pertaining to merchants that desire to provide incentives to their shoppers in exchange for performing certain tasks. By way of example and not of limitation, a clothing store merchant may want to provide a $5 discount to cardholders who spend more than $50 and posts on a social media website (e.g., tweets) about their shopping activity from this clothing store. The payment instrument database (711) can comprise information pertaining to each of the payment instruments added to the list of payment instruments by the user of the intermediary account. Such information can include award and/or incentive information such as, for example, payment instrument A offers 1.5% cash rebate on all purchases, payment instrument B offers 2% reward points on all purchases, payment instrument C offers 2 reward miles, etc. The privacy and preference database can comprise the user's privacy settings and/or preferences. By way of example and not of limitation, the user may prefer cash rebates over earning airlines miles. Additionally, the user may not want to disclose to the merchants regarding his spending habit and thus may not desire to be provided with incentive offers from the merchant. Such merchant offer, payment instrument incentive information, and privacy and preference information can be provided to the optimization engine (709), which processes all of this information and decides which payment instrument it should forward the approval request to.

Once a payment instrument has been selected by the optimization engine (709), the approval request is forwarded to a real time funding (713) which then forwards the request to the selected payment instrument issuer (e.g., bank) (716) via a second merchant acquirer (714) and a second network gateway (715). The second merchant acquirer (714) and a second network gateway (715) are referred to as the second payment network in FIG. 1. The second merchant acquirer (714) and the second network gateway (715) is a separate and independent process from the first merchant acquirer (702) and first network gateway (703) mentioned earlier when the financial card was initially read. Although they are a separate and independent process, the second merchant acquirer (714) and the first merchant acquirer (702), and the second network gateway (715) and the first network gateway (703) can be the same.

The payment instrument issuer (716) processes the authorization request and either approves or disapproves the request. The approval or the disapproval indication is forwarded back to the intermediary account (705) via the second network gateway (717) and the second merchant acquirer (718) to a settlement processor (719), which performs one of two possible functions depending on whether the request is approved or disapproved. If the request is approved, a settlement request (721) is sent to the payment instrument issuer to obtain funding of authorized amount. If the request is declined, then the settlement process does not occur. The approval or disapproval decision is sent back to the front side transaction (720).

Referring back to FIG. 7A, while the back end transaction (707) is taking place, the intermediary account (705) waits (722) for an approval or disapproval indication from the payment instrument issuer (716). The amount of time that the intermediary account (705) can wait for a response can be set according to desired parameters. By way of example and not of limitation, if the merchant's card processing device expects a response (e.g., approval or disapproval) within 1.4 seconds, then the intermediary account (705) can be configured to wait 2 seconds. If the request is approved, then the approval indication is forwarded back to the merchant via the card processor (730), the first network gateway (724), and the first merchant acquirer (725), where the sales transaction can be completed. If a signature is required, the user can sign the sales receipt (726).

In some embodiments, if the request is approved, the intermediary account (705) can provide a savings alert (727) (as described earlier) to the user to inform the user how many reward points, reward miles, or cash back was earned from this transaction.

In some embodiments, if the request is disapproved by the payment instrument issuer, or if the request is not responded to within the set time period (e.g., due to system delays, communication errors, etc.), the intermediary account (705) can independently consider the approval request via a fall-back underwriter (723). In other words, in order to increase the possibility of the approval for the approval request, the user is provided with a secondary opportunity to potentially receive the approval. Thus, in the event that the intermediary account (705) does not receive an approval from the payment instrument issuer (whether by disapproval or no response), the intermediary account (705) can independently consider the approval request and independently approve the request, even though the payment instrument issuer has not provided the approval. By way of example and not of limitation, the intermediary account may approve a request for a particular account holder that has an established credit history, whereas if the account holder was a brand new customer with no history, the request may be disapproved by the fall-back underwriter. When the fall-back underwriter (723) approves the request, the intermediary account (705) can provide a temporary line of credit for the account holder. At a later moment, the intermediary account (705) can send another request to the payment instrument issuer or even send another request to a different payment instrument that is associated with the same consumer's account.

Finally, if the approval request is disapproved by both the payment instrument issuer (716) and the optional fall-back underwriter (723), the disapproval indication is forwarded back to the merchant's card processing device (731) via the card processor (728), the first network gateway (729), and the first merchant acquirer (730).

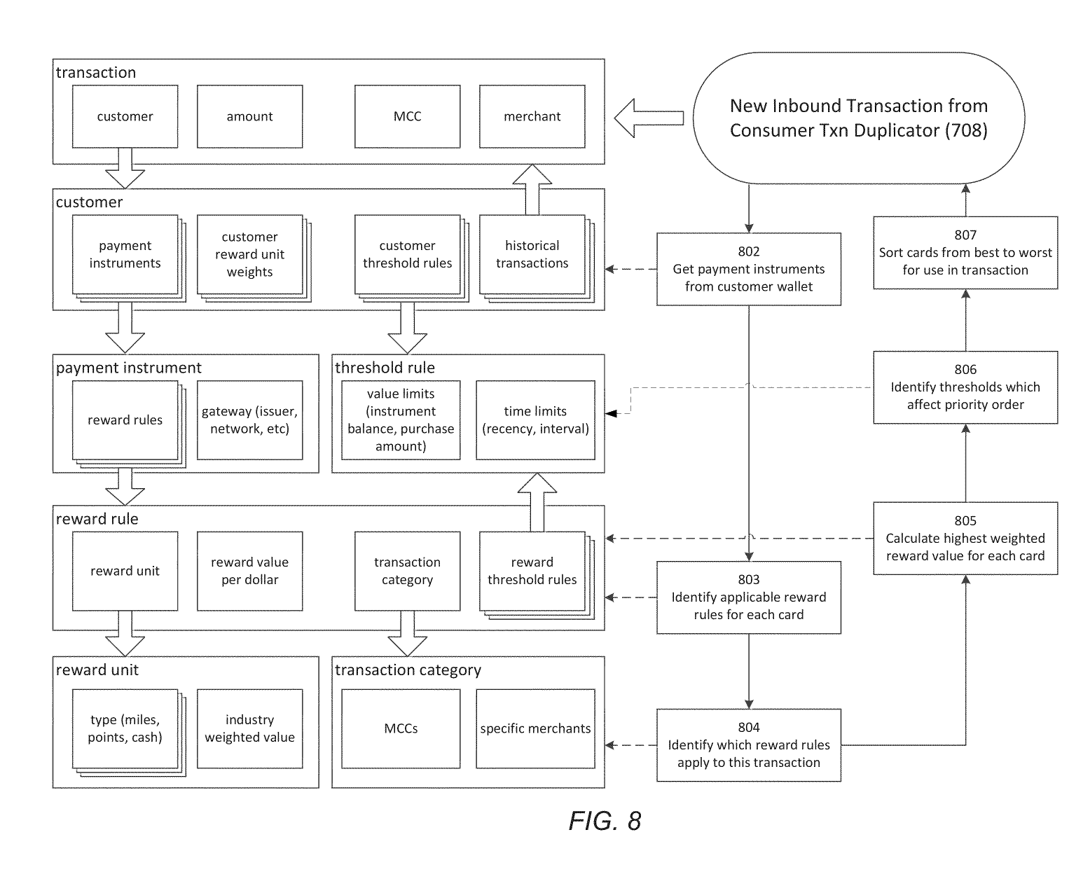

Turning back to the optimization engine (709) in the intermediary account (707), where the optimization engine (709) processes a decision according to a set of rules as shown by a flow chart in FIG. 8, when the optimization engine (709) receives the transaction record, the optimization engine (709) considers transaction elements such as, identification of the cardholder whose financial card is associated with the transaction, the purchase amount, the merchant category code (MCC) of the transaction, and the merchant's name as presented by the issuer processor as inputs to the decision making process.

By associating the financial card number from the issuer processor to the customer record database in the intermediary account, the optimization engine (709) can obtain a list of attributes and preferences associated with this particular customer's record (802) from the database. Such attributes and preferences can include active payment instruments, historical transaction information, limit preferences on certain payment instruments, reward earning preferences/priority (e.g., miles over points, points over cash), and reward unit weights (e.g., specific monetary values a customer assigns to a particular type of reward such as credit card air miles, or cash back bonuses) given by a particular payment instrument.

Each payment instrument can have zero or more reward rules associated with it (803). By way of example and not of limitation, reward rules can comprise a reward unit, a percentage value per dollar, a set of applicable transaction categories, and a set of zero or more thresholds associated with the reward. The thresholds can be, for example, duration, maximum earn in a particular interval of time, minimum spend required to trigger earning, etc.

In some instances, certain rules may not be applicable to certain merchants, which can be determined by the MCC and/or the merchant name associated with the current transaction record. For example, a particular rule can state that a certain credit card can earn 5% cash rebate to gas purchases. Therefore, in such case, if a purchase is made at a restaurant, this rule can be filtered out as not being applicable to this transaction, thus limiting the set of total reward rules that require computation (804) by the computer.

A total potential reward value can be calculated (805) for each rule that is applicable (e.g., rules that have not been filtered out). The total potential reward value can be calculated by multiplying the (reward value per dollar)×(purchase amount)×(reward unit weight), where the reward unit weight can be selected from either an industry default value or a customer override value.

A list of total potential reward values is generated, where each reward is tied to one of the payment instruments associated with the user. Once the list is generated, each reward rule is analyzed for any threshold rules (806). A “threshold rule” can be defined as a rule that imposes limits on a reward's validity, for example, a credit card program that specifies that a maximum of $1,500 in qualifying purchases per quarter is eligible for 5% cash back rewards. A threshold rule can also weigh user preferences of one reward rule based on the reward achieving a designated milestone, for example, achieving 50,000 points with a particular credit card program qualifies the user for a vacation package. Therefore, the user may prefer to earn a vacation package from a particular credit card over earning airline miles for another card. Then the threshold rule can apply such rule (set by the user by way of preference settings). The threshold rules can be derived from card program terms of service or from customer-enabled preferences. Threshold rules are applied after reward value calculations so that if there are any potential rewards that are lost due to existing threshold filters, such information can be recorded for future analysis and recommendations to both users and payment instrument issuers.

The remaining potential reward values are sorted first by priority bucket based on threshold scoring, and then by the total reward value (807). This sorted list is returned from the optimization engine (709) to the transaction duplicator (708) in order to request authorization from the card issue of the card with the highest priority.

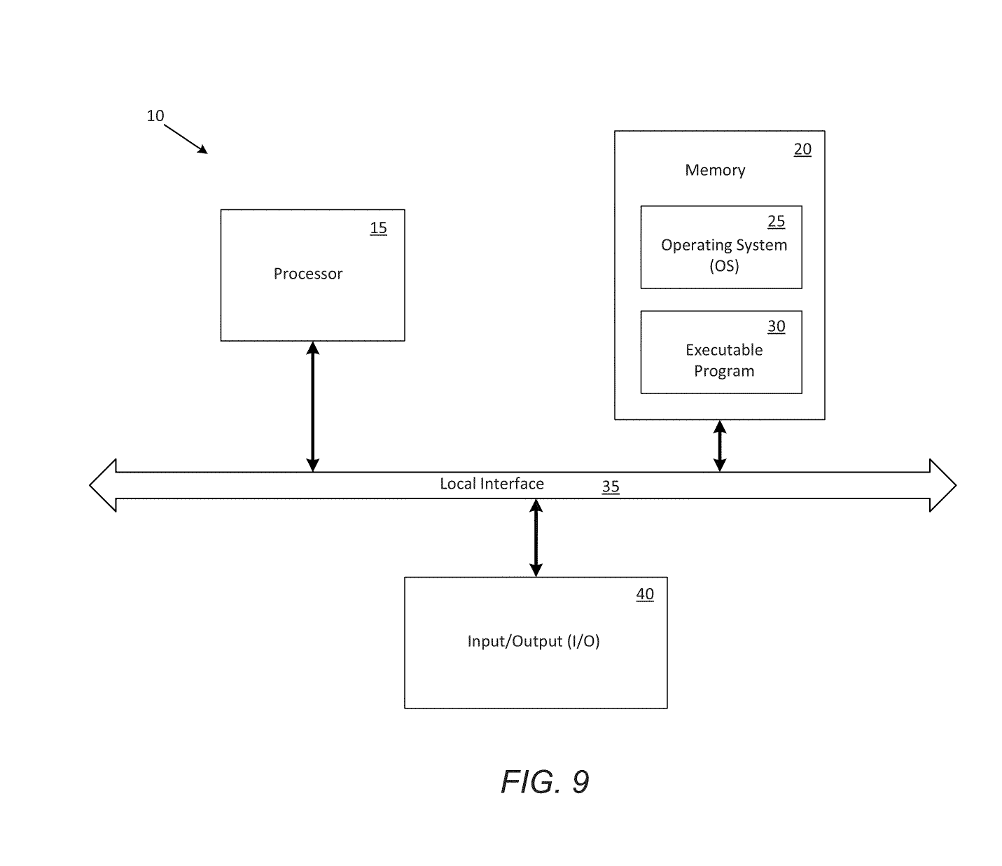

FIG. 9 shows a computer system (10) that may be used to implement the system for optimizing card usage in a payment transaction of the present disclosure. It should be understood that certain elements may be additionally incorporated into computer system (10) and that the figure only shows certain basic elements (illustrated in the form of functional blocks). These functional blocks include a processor (15), memory (20), and one or more input and/or output (I/O) devices (40) (or peripherals) that are communicatively coupled via a local interface (35). The local interface (35) can be, for example, metal tracks on a printed circuit board, or any other forms of wired, wireless, and/or optical connection media. Furthermore, the local interface (35) is a symbolic representation of several elements such as controllers, buffers (caches), drivers, repeaters, and receivers that are generally directed at providing address, control, and/or data connections between multiple elements.

The processor (15) is a hardware device for executing software, more particularly, software stored in memory (20). The processor (15) can be any commercially available processor or a custom-built device. Examples of suitable commercially available microprocessors include processors manufactured by companies such as INTEL®, AMD®, and MOTOROLA®.

The memory (20) can include any type of one or more volatile memory elements (e.g., random access memory (RAM, such as DRAM, SRAM, SDRAM, etc.)) and nonvolatile memory elements (e.g., ROM, hard drive, tape, CDROM, etc.). The memory elements may incorporate electronic, magnetic, optical, and/or other types of storage technology. It must be understood that the memory (20) can be implemented as a single device or as a number of devices arranged in a distributed structure, wherein various memory components are situated remote from one another, but each accessible, directly or indirectly, by the processor (15).

The software in memory (20) may include one or more separate programs, each of which comprises an ordered listing of executable instructions for implementing logical functions. In the example of FIG. 9, the software in the memory (20) includes an executable program (30) that can be executed to implement the system for optimizing card usage in a payment transaction in accordance with the present disclosure. Memory (20) further includes a suitable operating system (OS) (25). The OS (25) can be an operating system that is used in various types of commercially-available devices such as, for example, a personal computer running a WINDOWS® OS, an APPLE® product running an APPLE®-related OS, or an ANDROID® OS running in a smart phone. The operating system (22) essentially controls the execution of executable program (30) and also the execution of other computer programs, such as those providing scheduling, input-output control, file and data management, memory management, and communication control and related services.

Executable program (30) is a source program, executable program (object code), script, or any other entity comprising a set of instructions to be executed in order to perform a functionality. When a source program, then the program may be translated via a compiler, assembler, interpreter, or the like, and may or may not also be included within the memory (20), so as to operate properly in connection with the OS (25).

The I/O devices (40) may include input devices, for example but not limited to, a keyboard, mouse, scanner, microphone, etc. Furthermore, the I/O devices (40) may also include output devices, for example but not limited to, a printer and/or a display. Finally, the I/O devices (40) may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the computer system (10) is a PC, workstation, or the like, the software in the memory (20) may further include a basic input output system (BIOS) (omitted for simplicity). The BIOS is a set of essential software routines that initialize and test hardware at startup, start the OS (25), and support the transfer of data among the hardware devices. The BIOS is stored in ROM so that the BIOS can be executed when the computer system (10) is activated.

When the computer system (10) is in operation, the processor (15) is configured to execute software stored within the memory (20), to communicate data to and from the memory (20), and to generally control operations of the computer system (10) pursuant to the software. The audio data spread spectrum embedding and detection system and the OS (25), in whole or in part, but typically the latter, are read by the processor (15), perhaps buffered within the processor (15), and then executed.

When the system for optimizing card usage in a payment transaction is implemented in software, as is shown in FIG. 9, it should be noted that the system for optimizing card usage in a payment transaction can be stored on any computer readable storage medium for use by, or in connection with, any computer related system or method. In the context of this document, a computer readable storage medium is an electronic, magnetic, optical, or other physical device or means that can contain or store a computer program for use by, or in connection with, a computer related system or method.

The system for optimizing card usage in a payment transaction can be embodied in any computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable storage medium” can be any non-transitory tangible means that can store, communicate, propagate, or transport the program for use by or in connection with the instruction execution system, apparatus, or device. The computer readable storage medium can be, for example but not limited to, an electronic, magnetic, optical, electromagnetic, infrared, or semiconductor system, apparatus, or device. More specific examples (a non-exhaustive list) of the computer-readable storage medium would include the following: a portable computer diskette, a random access memory (RAM), a read-only memory (ROM), an erasable programmable read-only memory (EPROM, EEPROM, or Flash memory) an optical disk such as a DVD or a CD.

In an alternative embodiment, where the system for optimizing card usage in a payment transaction is implemented in hardware, the system for optimizing card usage in a payment transaction can implemented with any one, or a combination, of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The examples set forth above are provided to give those of ordinary skill in the art a complete disclosure and description of how to make and use the embodiments of the present disclosure, and are not intended to limit the scope of what the inventors regard as their disclosure. Modifications of the above-described modes for carrying out the disclosure may be used by persons of skill in the art, and are intended to be within the scope of the following claims. All patents and publications mentioned in the specification may be indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a”, “an”, and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

A number of embodiments of the disclosure have been described. Nevertheless, it will be understood that various modifications may be made without departing from the spirit and scope of the present disclosure. Accordingly, other embodiments are within the scope of the following claims.

1. A computer implemented method of optimizing usage of payment instruments for an individual, the method comprising:
establishing an intermediary account comprising an optimization engine, the intermediary account being associated with a plurality of payment instruments;
receiving, by the optimization engine, a first transaction approval request from a single financial card provided by the individual, wherein the first transaction approval request comprises computer processable transaction data and data requesting approval of a transaction;
processing the computer processable transaction data, by the optimization engine, with instructions provided from one or more databases, the one or more databases comprising merchant offer instructions, payment instrument offer instructions, privacy instructions, and preference instructions;
selecting, by the optimization engine according to the instructions, one or more payment instruments from the plurality of payment instruments to charge a requested amount; and
transmitting a second transaction approval request to the selected one or more payment instruments, the second transaction approval request comprising a forwarded version of the first transaction approval request, thus sending the first transaction approval request to the selected one or more payment instruments via the optimization engine.

2. The method according to claim 1, wherein the selecting comprises choosing the one or more payment instruments having a highest reward.

3. The method according to claim 2, wherein the reward is in a form of cashback, reward points and/or airline mileage.

4. The method according to claim 1, wherein the payment instrument is selected from the group consisting of: credit card, bank card, debit card, ATM card, store card, pre-paid card, and gift card.

5. The method according to claim 1, wherein the privacy instruction is configured by the individual.

6. The method according to claim 1, wherein the preference instruction is configured by the individual.

7. The method according to claim 1, wherein the instructions for the selecting is a set of rules to minimize interest charges on the payment instruments.

8. The method according to claim 1, wherein the instructions for selecting is a set of rules to maintain a set balance across a plurality of payment instruments, the balance being set by the individual.

9. A computer implemented method of optimizing payment instrument usage for an individual, the method comprising:
establishing an intermediary account through the computer;
associating, through the computer, a plurality of payment instruments with the intermediary account;
performing a point-of-sale (POS) transaction on a merchant card processing device, wherein the transaction comprises an approval request, wherein the approval request comprises computer processable transaction data and data requesting approval or disapproval of completion of the POS transaction;
routing the approval request, by the computer, to the intermediary account;
determining, by the intermediary account through the computer, one or more payment instruments from the plurality of associated payment instruments, that provides a maximum reward for the individual according to instructions stored in one or more databases associated with the intermediary account; and
routing the approval request, by the computer, to a payment instrument issuer of the determined one or more payment instruments, thus requesting an approval or disapproval of completion of the POS transaction from the payment instrument issuer.

10. The method according to claim 9, wherein if the request is approved, an indication of approval is provided to the merchant card processing device.

11. The method according to claim 10, further comprising the intermediary account obtaining funds from the payment instrument issuer, and the intermediary account providing funds to a merchant using the merchant card processing device.

12. The method according to claim 9, wherein the determining further comprises:
filtering out, by the computer, rules for each of the plurality of payment instruments associated with the intermediary account based on merchant category codes and/or name of merchant associated with the POS transaction;
calculating a potential reward value for each of the plurality of payment instruments associated with the intermediary account;
applying a set of threshold rules to each of the calculated potential reward values;
generating a list of rules with remaining rules; and
sorting the list of rules according to priority of the calculated potential reward values and threshold rules.

13. The method according to claim 12, wherein the potential reward value is a product of a reward value per dollar, purchase amount of the POS transaction, and a reward unit weight.

14. The method according to claim 13, wherein the reward unit weight is an industry default value or a value selected by the individual.

15. A computer implemented system comprising:
a server connected with a network, the server comprising an optimization engine configured to optimize usage of payment instruments for an individual, and a first plurality of databases configured to store a list of attributes and preferences associated with the individual's record; and
a merchant payment system connected to the server through the network, the merchant payment system configured to route a point-of-service (POS) transaction from a merchant to the server, and from the server to a selected one or more payment instrument,
wherein the server comprises computing hardware and computing software configured for execution on the computing hardware, wherein the computing software comprises:
software configured to establish an intermediary account comprising the optimization engine, the intermediary account being associated with a plurality of payment instruments;
software configured to receive, by the optimization engine, a first transaction approval request from a single financial card provided by the individual, wherein the first transaction approval request comprises computer processable transaction data and data requesting approval of a transaction;
software configured to process the computer processable transaction data, by the optimization engine, with instructions provided from a second plurality of databases, the second plurality of databases comprising merchant offer instructions, payment instrument offer instructions, privacy instructions, preference instructions, and the first plurality of databases;
software configured to select, by the optimization engine according to the instructions, one or more payment instruments from the plurality of payment instruments to charge a requested amount; and
software configured to transmit a second transaction approval request to the selected one or more payment instruments, the second transaction approval request comprising a forwarded version of the first transaction approval request, thus sending the first transaction approval request to the selected one or more payment instruments via the optimization engine.

16. The system according to claim 15, where the list of attributes is one or more selected from the group consisting of: active payment instruments, historical transaction information, limit preference on certain payment instruments, reward earning preferences, reward earning priorities, and reward unit weights.

17. The system according to claim 15, wherein the network is the Internet.

18. The system according to claim 15, further comprising a portable electronic device connected with the network and having a display screen, the portable electronic device configured to display the selected one or more payment instruments.

19. The method of claim 1, wherein location of the first transaction approval request is remote from location of the optimization engine.

20. The method of claim 9, wherein location of the POS transaction is remote from location of the intermediary account.

21. The method according to claim 1, wherein transmitting the second transaction approval request comprises transmitting the second transaction approval request upon selection of the one or more payment instruments by the optimization engine and wherein the individual does not intervene in the selection of the one or more payment instruments by the optimization engine.

22. The method according to claim 1, wherein establishing the intermediary account occurs prior to receiving the first transaction request and wherein establishing the intermediary account comprises the individual specifying one or more payment instruments.

23. The method according to claim 1, the method further comprising:
storing, in one or more databases associated with the intermediary account, reward valuation and prioritization rules, preference instructions and privacy instructions for each payment instrument, wherein the reward valuation and prioritization rules, preference instructions and privacy instructions are configured by the individual,
wherein the one or more databases further comprise the individual's reward valuation and prioritization rules and wherein the privacy instructions comprise the individual's privacy instructions and the preference instructions comprise the individual's preference instructions,
and wherein selecting, by the optimization engine, comprises selecting according to the instructions and the individual's reward valuation and prioritization rules.

24. The method of claim 23, wherein the reward valuation and prioritization rules are programmed in the form of routing rules for routing the second transaction approval request to the selected one or more payment instruments

25. The method according to claim 9, wherein routing the request to a payment instrument issuer of the determined one or more payment instruments comprises routing the request upon determination of the one or more payment instruments and wherein the individual does not make a selection of the one or more payment instruments after the intermediary account determines the one or more payment instruments.

26. The method according to claim 9, wherein establishing the intermediary account occurs prior to performing the POS transaction and wherein establishing the intermediary account comprises the individual specifying one or more payment instruments.

27. The method according to claim 9, the method further comprising:
storing, in one or more databases associated with the intermediary account, reward valuation and prioritization rules, preference instructions and privacy instructions for each payment instrument, wherein the reward valuation and prioritization rules, preference instructions and privacy instructions are configured by the individual,
and wherein determining, by the intermediary account, comprises determining, by the intermediary account through the computer, the one or more payment instruments from the plurality of associated payment instruments, that provides a maximum reward for the individual according to instructions and rules stored in the one or more databases associated with the intermediary account.
